(19) United States
(12) Patent Application Publication
(10) Pub. No.: US 2019/0139059 A1
(43) Pub. Date: May 9, 2019

(54) DEMAND FORECASTING DEVICE, DEMAND FORECASTING METHOD AND NON-TRANSITORY COMPUTER READABLE MEDIUM

(71) Applicant: KABUSHIKI KAISHA TOSHIBA, Minato-ku (JP)

(72) Inventors: Yoshiaki SHIGA, Kawasaki (JP); Hiromasa SHIN, Yokohama (JP); Mitsuru KAKIMOTO, Kawasaki (JP); Masaaki TAKADA, Kita (JP)

(73) Assignee: KABUSHIKI KAISHA TOSHIBA, Minato-ku (JP)

(21) Appl. No.: 15/918,373

(22) Filed: Mar. 12, 2018

(30) Foreign Application Priority Data
Nov. 7, 2017 (JP) 2017-214773

(51) Int. Cl. G06Q 30/02; G06N 99/00

(52) U.S. Cl. CPC G06Q 30/0202; G06N 99/005

(57) ABSTRACT

According to one embodiment, a demand forecasting device includes a location model generator and an overall model generator. The location models generate each providing a forecasted value of demand for a geographical region including a plurality of locations, based on weather data for either of the plurality of locations and previous value of demand for the geographical region. The overall model generator generates an overall model based on the location models and coefficients that are determined based on size of impact to the forecasted value of demand, by the weather data of the locations.

### CROSS-REFERENCE TO RELATED APPLICATIONS

This application is based upon and claims the benefit of priority from Japanese Patent Application No. 2017-214773, filed on Nov. 7, 2017; the entire contents of which are hereby incorporated by reference.

### FIELD

Embodiments described herein relate generally to a demand forecasting device, a demand forecasting method and a non-transitory computer readable medium.

### BACKGROUND

Recently, methods to improve the accuracy of demand forecasts by using models generated by machine learning are being investigated. Conditions of weather are factors which are common for various demand forecasts. For example, it is widely known that depending on the conditions of weather, the demand of electricity, demand of water, sales of products, number of users in services or the like fluctuate. Therefore, a technology which enables accurate forecasts of demands based on weather data is needed.

Various methods have been proposed for demand forecasting. For example, by making adjustments which reflect current weather conditions to the value of demand for the same date in previous years, it is possible to obtain a predicted value of the demand. Also, it is possible to apply machine learning to weather data for a plurality of locations and previous value of demand and generate a prediction model. The former method is simpler but is limited in terms of accuracy. For the later method, the model becomes complicated, making it difficult to include weather data from a plurality of locations. Also, since there is multicollinearity within weather data, the learning may not converge.

### BRIEF DESCRIPTION OF THE DRAWINGS

FIG. 1 is a diagram showing components of a demand forecasting system according to the first embodiment;

FIG. 2 is a diagram showing the locations within a target area of demand forecasting;

FIG. 3 is a diagram showing weather data based on observed values;

FIG. 4 is a diagram showing weather data based on predicted values;

FIG. 5 is a diagram showing demand data including demand of electricity in the past;

FIG. 6 is a diagram showing attribute data saved in an attribute database;

FIG. 7 is a flowchart showing a generation process of a location model;

FIG. 8 is a diagram showing a response curve of the demand of electricity in respect to the temperature;

FIG. 9 is a diagram showing the response curve of the demand of electricity in respect to the amount of solar irradiance;

FIG. 10 is a diagram showing the result of demand forecast according to the location model;

FIG. 11 is a diagram showing a generation process of an overall model;

FIG. 12 is a diagram showing an example of a weight coefficient table for each location;

FIG. 13 is a diagram showing an example of weight coefficients for each location during daytime;

FIG. 14 is a diagram showing an example of weight coefficients for each location during nighttime;

FIG. 15 is a flowchart showing a demand forecasting process by the overall model;

FIG. 16 is a diagram showing a result of demand forecast according to the overall model;

FIG. 17 is a diagram showing components of a demand forecasting system according to the second embodiment;

FIG. 18 is a flowchart showing calculation of weather data according to a numerical weather prediction model;

FIG. 19 is a diagram showing hardware configuration of the demand forecasting device.

### DETAILED DESCRIPTION

According to one embodiment, a demand forecasting device includes a location model generator and an overall model generator. The location models generate each providing a forecasted value of demand for a geographical region including a plurality of locations, based on weather data for either of the plurality of locations and previous value of demand for the geographical region. The overall model generator generates an overall model based on the location models and coefficients that are determined based on size of impact to the forecasted value of demand, by the weather data of the locations.

Hereinafter, embodiments of the present invention will be described in reference to the drawings.

### First Embodiment

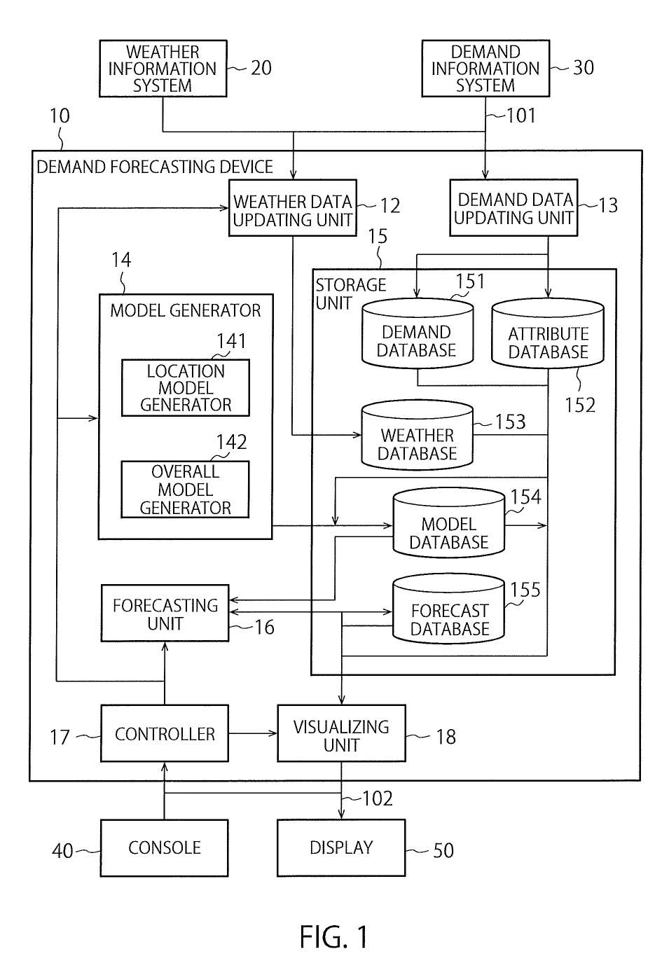

FIG. 1 is a block diagram showing a schematic configuration of a demand forecasting system according to a first embodiment. A demand forecasting system according to a first embodiment will be described in reference to FIG. 1.

A demand forecasting system in FIG. 1 includes a demand forecasting device 10, a weather information system 20, a demand information system 30, a console 40 and a display 50. The demand forecasting device 10, the weather information system 20 and the demand information system 30 are connected to each other via a network 101. The demand forecasting device 10, the console 40 and the display 50 are connected via a network 102.

Below, an overview of the demand forecasting device 10, which provides the main features of the demand forecasting system according to the embodiment, is explained.

The demand forecasting device 10 forecasts the value of demand in future based on weather data obtained from the weather information system 20 and the demand data including previous values of demand obtained from the demand information system 30. Weather data includes predicted values of weather and observed values of weather. In the following, a case where a forecast for the demand of electricity is being provided is explained as an example. However, the target of demand forecast is not limited. For example, the demand of water, the demand of gas, sales of products, number of visitors, number of passengers, number of accesses to a website, number of users in a service, number of patients in a medical institution or the like could be the target of demand forecast.

The demand forecast is executed specifying a geographical region. The size of geographical region is not limited. The geographical region could be global scale, a plurality of nations or a single country. Also, the geographical region could be a part of a country. Parts of countries include provinces, prefectures, cities, towns, villages or the like. Any specific area can be chosen as the geographical region. In the embodiment, a supply area of an electric company is configured as the geographical region for demand forecast.

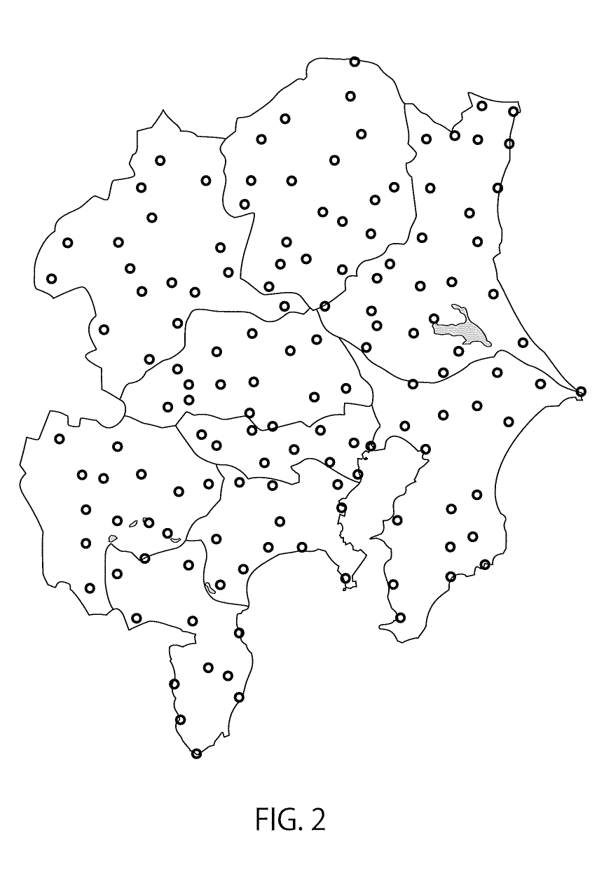

FIG. 2 is a diagram showing the locations within a geographical region (target area) of demand forecasting. FIG. 2 is a map including Tokyo metropolitan area, Kanagawa prefecture, Chiba prefecture, Saitama prefecture, Gunma prefecture, Tochigi prefecture, Yamanashi prefecture and an eastern part of Shizuoka prefecture. The area shown in the map of FIG. 2 corresponds to the supply area of an electric company. Here, the eastern part of Shizuoka prefecture is a section of Shizuoka prefecture which is located in the eastern side of Fuji River. Izu Islands and Ogasawara Islands belong to the Tokyo metropolitan area but are not shown in the map. The locations shown in the map of FIG. 2 are locations of meteorological stations (AMEDAS:Automated Meterological Data Acquisition System) operated by the Japan Meteorological Agency.

It is known that the demand of electricity depends on the weather condition. As shown in FIG. 2, the supply area of an electric power company extends to a size of few thousand square kilometers. The supply area includes places with various conditions, such as plains in low altitudes, mountainous areas in high altitudes, areas along the waterfront, basins in the inland, urban areas, rural areas or the like. Thus, the climate (weather conditions) varies depending on the locations.

There are different usages of land including residential districts, industrial districts, farmland and commercial districts. The trend in demand of electricity depends on the usage of land. For residential districts, the consumption of electricity increases in mornings and evenings of weekdays. In commercial districts, the consumption of electricity becomes the greatest during operating hours of offices. In industrial districts, the consumption of electricity becomes the greatest during busy seasons when there are a large number of orders. Compared to rural areas, the demand of electricity in urban areas fluctuates depending on the operation of air conditioning systems (cooling or heating). Thus, it is difficult to estimate the demand of electricity accurately for regions which include different usages of land using models that are too simplified.

Therefore, if weather data for a plurality of locations are included in the model which forecasts the demand of electricity, it is possible to reflect various weather conditions and usage of land in each area. Thus, the inclusion of a plurality of locations can improve the accuracy of the forecast for demand of electricity.

However, due to the complexity of models and multicollinearity within the weather data, it was difficult to learn a model including weather data of a plurality of locations while maintaining satisfactory levels of accuracy in the predictions. Thus, in the demand forecasting device 10 according to the embodiment, a relatively simple model is used to incorporate weather data from a plurality of locations, while maintaining the accuracy of predictions.

First, the demand forecasting device 10 obtains weather data and demand data corresponding to the geographical region which is the target of demand forecast. The demand data includes the total value of demand in the past, within the geographical region. The weather data includes observed values of weather and predicted values of weather for a plurality of locations within the geographical region. Then, based on the weather data from a plurality of locations, multiple models which predict the total value of demand within the geographical region are generated. Here, each model is called the location model.

Then, a model which predicts the total demand within the geographical region with a higher accuracy is generated by combining a plurality of location models. Here, the model which is a combination of a plurality of location models is called the overall model. Demand forecast could be executed after the overall model is generated. Thus, by entering the weather data of the target date time to the overall model, the demand forecasting device 10 can provide a forecasted value of demand. Beyond, if the location model and the overall model are not distinguished, the models are called the demand forecasting models. Also, the values predicted by the demand forecasting models are called the forecasted values of demand.

The demand forecasting device 10 provides features that enable the visualization of the results of demand forecasts. Thus, the users can verify the model during the generation of the demand forecasting models. Also, it is also possible to evaluate the estimated results during the actual operation of the demand forecasting device 10.

The following description was an overview of the features provided by the demand forecasting device 10. Details on the demand forecasting device 10 are mentioned later. In the following, the configuration of the demand forecasting system is described in reference to FIG. 1.

The demand forecasting device 10 generates the demand forecasting models and provides forecasted value of demand by using the models. The demand forecasting device 10 also visualizes the forecasted demands. The demand forecasting device is an information processing device such as a computer including one or more CPUs (Central Processing Units), a storage unit and a communication unit. An OS (Operating System) and an application can operate on the demand forecasting device. The demand forecasting device 10 can be a physical computer, a virtual machine (VM), a container or a combination of the above.

The weather information system 20 provides weather data to clients connected via a network. Examples of weather data include, values that were observed in the past, the newest observed values of weather, the predicted values of weather, initial values for the numerical prediction models or the like. The weather information system 20 can provide numerical prediction models as the weather data, besides data in numerical format. The weather information system 20 can be servers, web services or cloud services provided by domestic and foreign government agencies such as the Japan Meteorological Agency, private businesses or international organizations. A combination of different servers and services can be used.

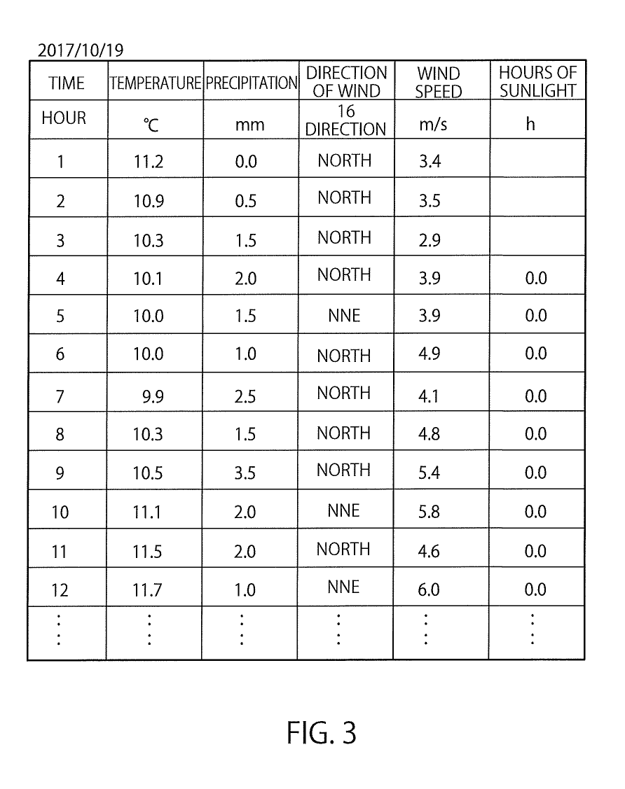

FIG. 3 is a diagram showing weather data based on observed values. FIG. 3 shows the observed values of weather in a meteorological station (AMeDAS location) of the Japan Meteorological Agency in Oct. 19, 2017. From the left to right, items including the time, the temperature, the precipitation, the direction of wind, the wind speed and the hours of sunlight are shown. The measured items could be different depending on the meteorological station. For example, there could be a meteorological station with more items of observations. Also, the items of observation could be less than the example shown in FIG. 3. For example, in the AMeDAS, there are locations where only the precipitation is observed.

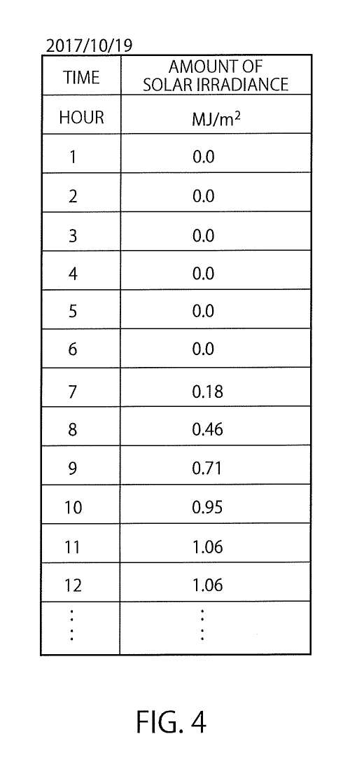

FIG. 4 is a diagram showing weather data based on predicted values. FIG. 4 shows the predicted values of solar irradiance within a lattice, based on images taken from weather satellites. The amount of solar irradiance is shown in units of MJ/m². However, the values could be converted to different units. Thus, the weather data could include predicted values of weather besides the observed values of weather.

The demand forecasting device 10 accesses the weather information system 20 as a terminal for obtaining weather data. The method used for accessing and the format of provided data are not limited.

The weather information system 20 can operate as a server in the client-server system. In such cases, the weather information system 20 sends the requested weather data to the client when a request is received from the client. Also, the weather information system 20 can be a distribution server which distributes weather data periodically to subscribed terminals. In this case, the terminals can subscribe to the distribution service for obtaining weather data. The weather information system 20 can also be a cloud storage service. In such cases, the terminal could access the database or files within the cloud storage for downloading the weather data. The weather information system 20 can be provided as a web service as well. In this case, the terminals obtain the weather data by using WEB APIs. Examples of the WEB API include XML, JSON or the like. However, other formats can be used.

The demand information system 30 provides the demand data (previous value of demand) to terminals connected via a network. The demand data includes previous values of demands coupled with time information. For the previous values of demands, it is possible to use the actual usage of electricity within a supplying area of an electric power company. If the target for demand forecast is the demand of water, the amount of water used in the past could be used. If the target for demand forecast is the demand of a certain product, the sales of the corresponding product, the number of products that were sold, the number of shipments, the number of production or the like could be used as the demand data (previous value of demand).

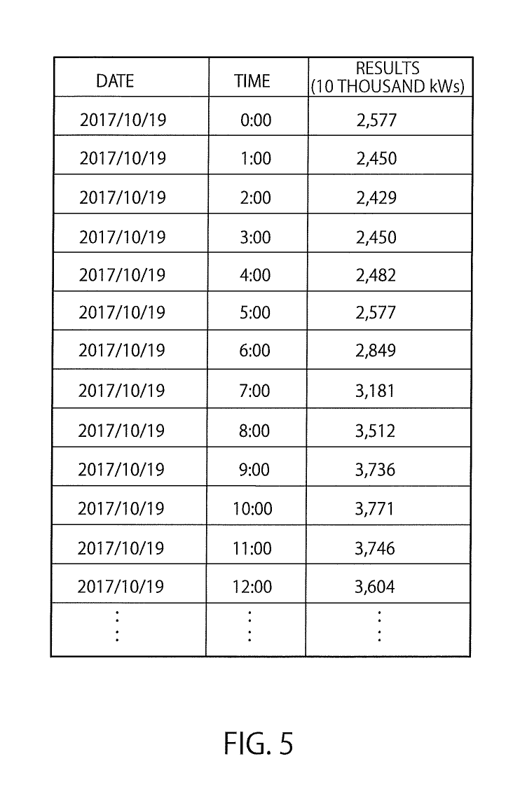

FIG. 5 is a diagram showing demand data including demand of electricity in the past. In the table shown in FIG. 5, the columns correspond to the date, the time, and the amount of electricity that was used, from the left to right. The amount of electricity that was used is the total value of electricity used in the geographical region shown in FIG. 2. The amount of electricity that was used is shown in units of 10,000 kW. However, other values can be used for the demand of electricity in the past. For example the amount of electricity provided by each type of electric power station, including thermal, nuclear, hydroelectric, pumped-storage, solar, wind power, geothermal or any other method. It is also possible to use the utilization factor as the demand of electricity in the past.

The demand information system 30 can also provide attribute data for each date time. The attribute data indicates events and specific conditions that may have affected the values of demand in the past. Specific conditions that may affect the demand of electricity include, daytime, midnight, commuting time, evening, seasons, long holidays, weekdays, weekends, summer, winter or the like. Events that may affect the demand of electricity include large-scale sports events, festivals or the like.

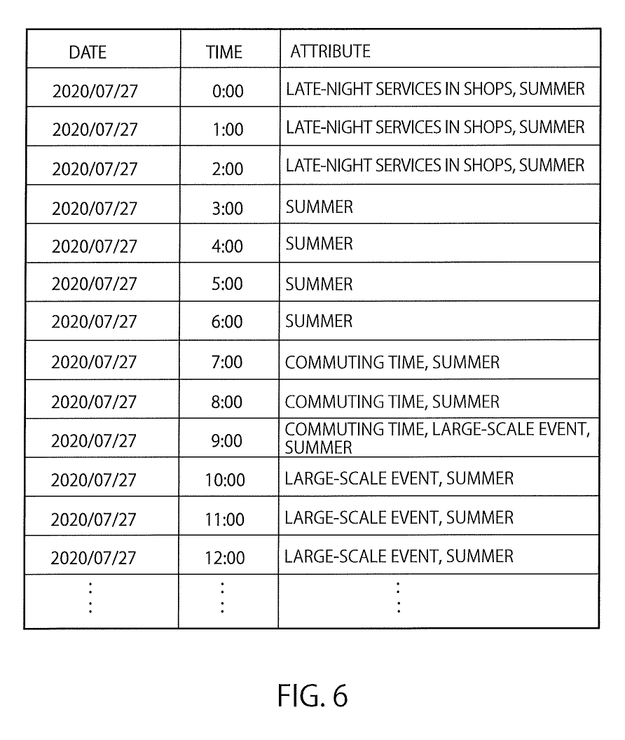

FIG. 6 is a diagram showing attribute data saved in an attribute database. In the example of FIG. 6, the attribute data for Jul. 27, 2020 is shown. In Jul. 27, 2020 a large-scale international sports event is held in the geographical region of demand forecast. Thus, it is expected that the number of both domestic and foreign visitors would increase. For example, if the midnight operating hours of shops, restaurants and bars are extended, increasing the number of customers, the attribute “late-night services in shops” is configured between 0:00 AM and 2:00 AM. If various games start from 9:00 AM, the attribute “large-scale event” is set for 9:00 AM and beyond. Also, since it is expected that the temperature during Jul. 27, 2020 becomes high, the attribute “summer” is set for all the hours. By using the attribute data, it is possible to reflect temporary increase in the demand of electricity to the demand forecast.

Demand information system 30 is a server, a web service, a cloud service or a combination of these provided by the electric power company, domestic government agencies, foreign government agencies, industrial associations or the like. The demand forecasting device 10 accesses the demand information system 30 as a terminal to obtain demand data including previous values of demand. As mentioned in the explanation for the weather information system 20, the method for access and the format of the data provided is not limited.

The network 101 enables communication of data between the weather information system 20, the demand information system 30 and the demand forecasting device 10. It is possible to use optical fiber, LAN cables, telephone lines, coaxial cables, wireless or the like for the communication media, regarding the network 101. It is also possible to combine multiple types of communication media. It is possible to use Ethernet or wireless LAN for communication standards. However, other communication standards can be used.

The console 40 accepts various operations from the users. For example, operations related to the generation of the demand forecasting models, visualization of the forecasts could be accepted from the users. The console 40 is a mouse, a keyboard, a touch panel, a trackball, a joystick, a pen-tablet, a voice recognition device, an image recognition device or a combination of above, for example. The console 40 can be a peripheral device of the demand forecasting device 10. It can be also a computer, a tablet, a smartphone, a cellular phone placed at a location remote from the demand forecasting device 10.

Although only a single console 40 is illustrated in the demand forecasting system of FIG. 1, a plurality of consoles 40 can be configured.

The display 50 can present visual information to the users. For example, the display 50 shows visualized weather data, demand data, results of demand forecasts or the like. Also, the display 50 can show GUIs (Graphical User Interfaces) that are used for accepting various operations from the users. The display 50 can be a liquid crystal display, an organic electroluminescence display, a LED (Light Emitting Diode) display, a CRT (Cathode Ray Tube) display, a projector or some other display, for example.

The installation and size of the display 50 is not limited. For example, the display 50 can be a small display used in information terminals such as personal computers, tablets, smartphones, cellular phones or the like. The display 50 can be a thin-screen television. Also, large screen displays installed outdoors could be used.

Although only a single display 50 is shown in the demand forecasting system of FIG. 1, a plurality of displays 50 can be used. Also, the console 40 and the display 50 can be integrated in personal computers, tablets, smartphones or the like. The console 40 and the display 50 can be connected to the demand forecasting device 10 from remote locations. The console 40 and the display 50 could be peripheral devices of the demand forecasting device 10.

The network 102 enables communication of data between the console 40, the display 50 and the demand forecasting device 10. It is possible to use optical fiber, LAN cables, telephone lines, coaxial cables, wireless or the like for the communication media, for the network 102. It is also possible to combine different types of communication media. It is possible to use wired Ethernet, wireless LAN (IEEE 802.11 series or successor standards) for the communication standards. However, the type of communication standards used is not limited.

In the example shown in FIG. 1, the network 101 and the network 102 form separate networks. However, the network 101 and the network 102 can be connected to each other, forming a single network.

If the demand forecasting system including the demand forecasting device 10 is provided as a cloud service, it is possible to place the demand forecasting device 10 in a remote datacenter which is distant from the console 40 and the display 50 of the user. In this case, it is possible to use TCP/IP protocols for communication within the network 102.

If both the console 40 and the display 50 are peripheral devices of the demand forecasting device 10, it is possible to use interfaces such as the PCI Express, USB, UART, SDIO, serial ports, Bluetooth or the like.

In the description above, the configuration of the demand forecasting system was explained. Below, each component of the demand forecasting device 10 is described.

The demand forecasting device 10 includes a weather data updating unit 12, a demand data updating unit 13, a model generator 14, a storage unit 15, a forecasting unit 16, a controller 17 and a visualizing unit 18. The model generator 14 includes a location model generator 141 and an overall model generator 142 as internal components. The storage unit 15 includes a demand database 151, an attribute database 152, a weather database 153, a model database 154 and a forecast database 155 as internal components.

The weather data updating unit 12 obtains weather data from the weather information system 20. The weather data obtained by the weather data updating unit 12 can be weather data for a plurality of locations. However, the weather data can include values for only a single location. The weather data updating unit 12 can save the weather data directly to the weather database 153. Also, the weather data updating unit 12 can modify the weather data before saving into the weather database 153. For example, if measured values from a specific observation apparatus include a specific bias, it is possible to compensate the bias before saving.

The weather data updating unit 12 can obtain weather data from the weather information system 20 using various methods. For example, the weather data updating unit 12 can receive weather data that is provided by the weather information system 20 periodically. Also, the weather data updating unit 12 can receive weather data by sending requests to the weather information system 20. Also, it is possible to download the weather data stored in the weather information system 20 by using various APIs (Application Programming Interfaces). The weather data can be obtained automatically by programs. The weather data can be obtained upon the users' requests. Thus, the timing for obtaining the weather data is not limited.

The weather data updating unit 12 obtains weather data for a plurality of locations shown in FIG. 2, from the weather information system 20, for example. If weather data from AMeDAS meteorological stations are used, the weather data updating unit 12 obtains observed values of weather (for example, data in table of FIG. 3) for each location in FIG. 2 (AMeDAS meteorological stations). If the amount of solar irradiance is included in the weather data, the weather data updating unit 12 obtains predicted values of weather (for example, data in table of FIG. 4) for each location in FIG. 2 (AMeDAS meteorological stations).

Here, the weather data of places were AMeDAS meteorological stations are located were used. However, as long as the locations are within the geographical region for demand forecast, weather data for other locations can be used. For example, observed values of weather from meteorological stations operated by local governments, educational institutions, research institutes, business companies can be used as the weather data. Also, the predicted values of weather included in the weather forecasts by these institutions can be used as the weather data.

The demand data updating unit 13 obtains the demand data (previous values of demand) from the demand information system 30. The demand data updating unit 13 can save the demand data which was obtained directly to the demand database 151. Also, it is possible to modify the previous values of demand in the demand data before saving. For example, if the actual usage of electricity within the geographical region for forecasting the demand of electricity cannot be obtained directly from the demand information system 30, the actual usage of electricity within an area corresponding to the geographical region is calculated. If an accurate value cannot be calculated, it is possible to use estimated values. Also, the demand data updating unit 13 obtains the attribute data for each date time. The attribute data is saved in the attribute database 152.

The model generator 14 generates the model used for forecasting the demand based on the demand data (previous values of demand) stored in the demand database 151 and the weather data stored in the weather database 153. The model generator 14 includes the location model generator 141 and the overall model generator 142. The location model generator 141 generates the location models. The overall model generator 142 generates the overall models. The overall model is generated by combining a plurality of location models based on weather data of each location belonging to the geographical region for demand forecast. The generated location model and the overall model are saved in the model database 152 of the storage unit 15.

The model generator 14 can generate a plurality of overall models. It is possible to prepare different overall models depending on the attributes of the target date time of the demand forecast. The attributes include, daytime, midnight, commuting time, evening, seasons, long holidays, weekdays, weekends, sport games, festivals, events or the like, for example. Also, it is possible to generate overall models with different geographical regions for the demand forecast. If there is a plurality of overall models, it is possible to select the overall model to be used, thereby improving the accuracy of demand forecast. Details on the generation of models in the model generator 14 (location model generator 141 and overall model generator 142) are described later.

The storage unit 15 provides storage space for saving data such as weather data, demand data, attribute data, location models, overall models, results of demand forecasts, programs or the like. The storage unit 15 includes volatile memory such as SRAM, DRAM, non-volatile memory such as NAND, MRAM, FRAM, and storage devices such as hard disks, SSDs or a combination of above. Although the storage unit 15 is an internal component of the demand forecasting device 10 in the example of FIG. 1, it is possible to use external storage devices or cloud storage. Also, a combination of internal storage devices, external storage media, external storage devices, cloud storage or the like can be used.

The forecasting unit 16 provides demand forecasts of the target geographical region by using the generated overall model. The forecasting unit 16 can switch the overall models that are used depending on the target date time of the demand forecast. For example, if the target date time of the demand forecast is the commuting time in the winter, it is possible to use the overall model for commuting time during the winter. If target date time of the demand forecast is the daytime of a summer weekend, a corresponding overall model can be used. Also, a generic overall model can be used. If a generic overall model is used, it is possible to adjust offset values depending on specific conditions. The forecasting unit 16 can save the results of the demand forecast by the overall model in the forecast database 155. Details on the demand forecasting process executed by the forecasting unit 16 is described later.

The controller 17 instructs the components to execute the operations specified by the console 40. For example, if generation of model is requested, the controller 17 instructs the model generator 14 to generate a model. If the forecasting of demand is requested, the controller 17 instructs the forecasting unit 16 to provide forecasts of the demand.

The controller 17 also accepts responses provided from each component. For example, if the controller 17 receives the notice that the demand forecasting is completed from the forecasting unit 16, the controller 17 requests the visualizing unit 18 to show the result of the demand forecast and a message that the demand forecast is completed in the display 50.

The visualizing unit 18 generates graphics including the response curves for each factor, a map showing the weight coefficient for each location, results of the demand forecast or the like, for example. The visualizing unit 18 reads necessary data before generating the graphics. When the generation of graphics is complete, the corresponding image data is provided to the display 50. Also, the visualizing unit 18 generates the image data for operating screens such as the GUI (Graphical User Interface) and provides the corresponding data to the display 50.

Next, the databases 151-155 which are saved in the storage unit 15 are explained.

The demand data obtained from the demand information system is saved in the demand database 151. As shown in FIG. 5, the demand data is saved to the demand database 151 in a format which includes a combination of the date time and the value of demand.

The attribute data corresponding to each date time is saved in the attribute database 152. As shown in FIG. 6, the attribute data is saved to the attribute database 152 in a format which includes a combination of the date time and the corresponding specific conditions or events. By using the attribute data, it is possible to generate models that are accustomed to different conditions. Also, it is possible to add extra terms to the equation. The terms give effects to the forecasted values, corresponding to each attribute.

The weather data obtained from the weather information system 20 is saved in the weather database 153. As shown in FIG. 3, the weather data is saved in table formats including items such as the temperature, the precipitation, the direction of wind, the speed of wind, hours of sunlight or the like for each date time. As shown in FIG. 4, it is possible to save tables which store items such as the anticipated amount of solar irradiance for each date time or the like. Also, it is possible to merge the items in the observed values of weather and the items in the predicted values of weather, altogether in a single table.

Each location model and overall model is saved in the model database 154. If a plurality of overall models is saved, an identifier is assigned to each overall model. The identifiers can be character strings which describe the name of the overall model or descriptions of the specific conditions that the overall model should be applied. The identifiers can be alphanumeric characters which represent the timestamp the corresponding model was generated. Thus, the format of the identifiers is not limited.

The result of demand forecasts by the overall model is saved in the forecast database 155. The results of the demand forecasts includes at least the target date time for the demand forecast and the forecasted (predicted) value of the demand. If a forecast for the demand of electricity is executed, the forecasted value becomes the anticipated value of demand for electricity. The results of the demand forecasts can include the target geographical region, the identifiers of the overall model which was used, the date time of the weather data which served as the reference value for prediction.

The aforementioned databases are saved in the storage unit 15. It is possible to use data formats such as XML, JSON, CSV, binary or the like to save data in the database. All the databases do not need to be saved in uniform formats. Thus, different formats can be used for saving data.

The features of each component in the demand forecasting device 10 can be implemented with software (programs) which operate on processors such as the CPU (Central Processing Unit). It is also possible to use hardware circuitry such as FPGAs, ASICs or the like to implement features. Also, it is possible to use a combination of these.

Each component of the demand forecasting device 10 can be implemented with a single computer. It is also possible to use a combination of multiple servers. For example, the model generator 14 and the forecasting unit 16 can be located in different computers, instead of the same computer. If the demand forecasting device 10 is configured with a plurality of computers, each computer can be connected with each other by a TCP/IP network such as Ethernet or the like. The plurality of computers could be installed in the same datacenter. It is also possible to place the computers in different locations. It is possible to make the computers redundant for the sake of availability and load-balancing.

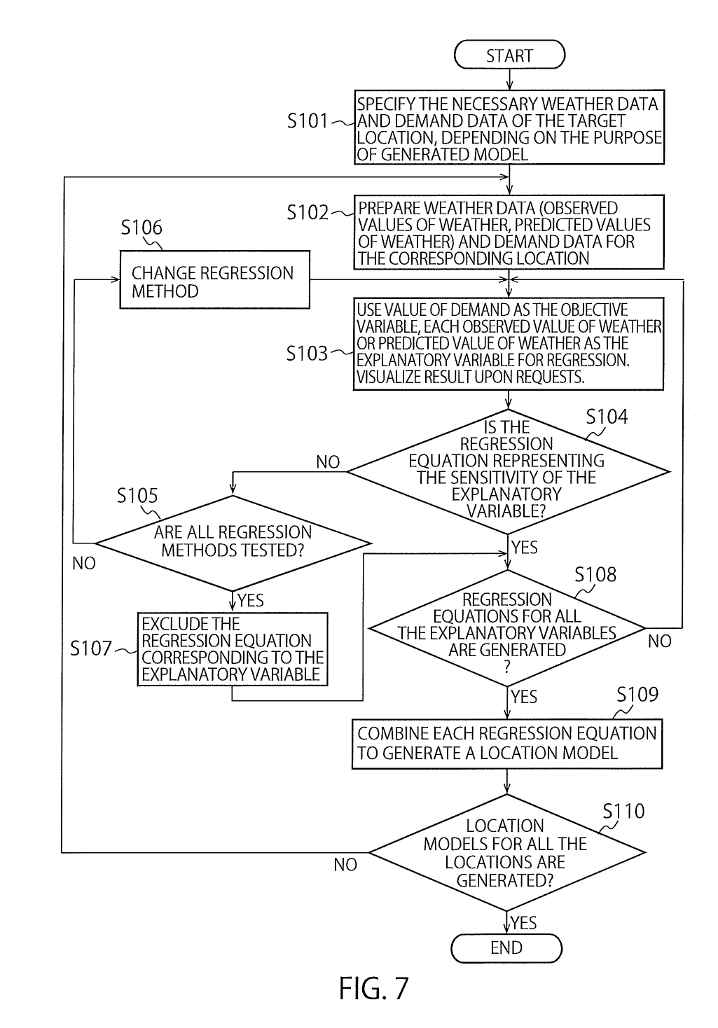

FIG. 7 is a flowchart showing a generation process of the location model. The process of generating the location model is executed for each location belonging to the geographical region for demand forecast. The location models use only the weather data for the respective location for providing the predicted value of demand for the whole geographical region. In the following, the process of generating the location model is described in reference to the flowchart in FIG. 7.

First, depending on the purpose of the generated model, the weather data and demand data which is required for the target location is specified (Step S101). The model generated here could be a model with limited applicable conditions or a general model. For example, if a model which predicts the demand of electricity for winter daytime is going to be generated, it is possible to use the weather data and the demand data for 10:00 AM to 3:00 PM in December, January and February in the past five years. If a general model is going to be generated, the weather data and the demand data in the past five years can be used without limiting the months (seasons) and the hours.

The purpose of the demand forecasting model can be determined based on the trend in the demand of electricity. For example, if the trend in the demand of electricity is different between weekdays and weekends, it is possible to prepare a model for daytime in winter weekdays and a model for daytime in winter weekends, separately. The demand forecasting model can be specialized for specific hours. For example, if the demand of electricity in January weekdays 8:00 AM is going to be generated, the weather data and demand data for January weekdays 8:00 AM is specified for the past five years.

If a model specialized for predicting the demand of electricity for a day for a large-scale festival is going to be generated, the weather data and the demand data for the date time when the same festival took place in the past years need to be specified. The exact date time when the same festival took place in past calendar years could be specified by referring to the demand data.

The number of years for the weather data and the demand data can be determined based on the changes in market and economic conditions within recent years. If the changes in the economic conditions are drastic, the data for the past two years are used. If the changes in the economic conditions are small, the data for the past ten years could be used.

Also, depending on the purpose of the demand forecasting model, the value of the correction (offset) term can be adjusted, without preparing a new model. In this case, it is possible to reduce the number of generated demand forecasting models. For example, when the demand of electricity for a period when a rare large-scale sports event is held, it is possible to set the value of the correction term to a positive value, in order to match the weather conditions and chronological conditions during the event. In this way, the generation of a new model is not needed. Details on the correction term are mentioned later.

The process of step S101 can be executed based on the instructions from the users. The process of step S101 can be also executed automatically by scripts or programs.

If the required data is specified, the corresponding weather data and demand data are prepared (Step S102). It is confirmed whether the required data is saved in the demand information database 151 or the weather database 153. If the required data is saved in the database, the data stored in the database is used. If data saved in the database is insufficient, required data is obtained from the weather information system 20 or the demand information system 30. The processes executed in the step follow the aforementioned descriptions for the weather data updating unit 12 and the demand data updating unit 13.

Next, regression is executed with the previous values of demand as the objective variable, the observed values of weather or predicted values of weather as the explanatory variables. The result of regression is visualized upon requests (Step S103). The graph visualized in this step is called the response curve. The method of regression can be linear regression, non-linear regression or machine learning models such as neural networks. Thus, any method could be used in this step.

In step S103 the response curve which is the result of regression is visualized as a graph, upon requests. The process of visualization can be executed automatically by programs. The process of visualization can be also executed by accepting requests from the users.

If regression is executed for a single explanatory variable, it is confirmed whether the regression equation is representing the sensitivity of the explanatory variable (Step S104). Thus, in step S104, it is confirmed whether the regression equation represents the relationship between the explanatory variable and the objective variable accurately. Methods for verifying the accuracy is not limited.

For example, if residual analysis is executed and the residual errors for each sample are scattered within the vicinity of 0 without a specific bias, it is possible to determine that the response curve is accurate. If the value of residual errors are distributed in the vicinity of values other than 0, or if there is a bias in the distribution, it could be determined that the response curve is not accurate. Residual analysis can be executed automatically by using scripts or programs.

It is possible to visualize the response curve in step S103. Then, the users can confirm the accuracy of the response curve. The users can confirm the response curve shown in the display 50. If the user determines that the response curve is accurate, it is possible to accept the regression equation by manipulating the console 40. If it is determined that the response curve is inaccurate, the users can manipulate the console 50 to exclude the corresponding regression equation from usage.

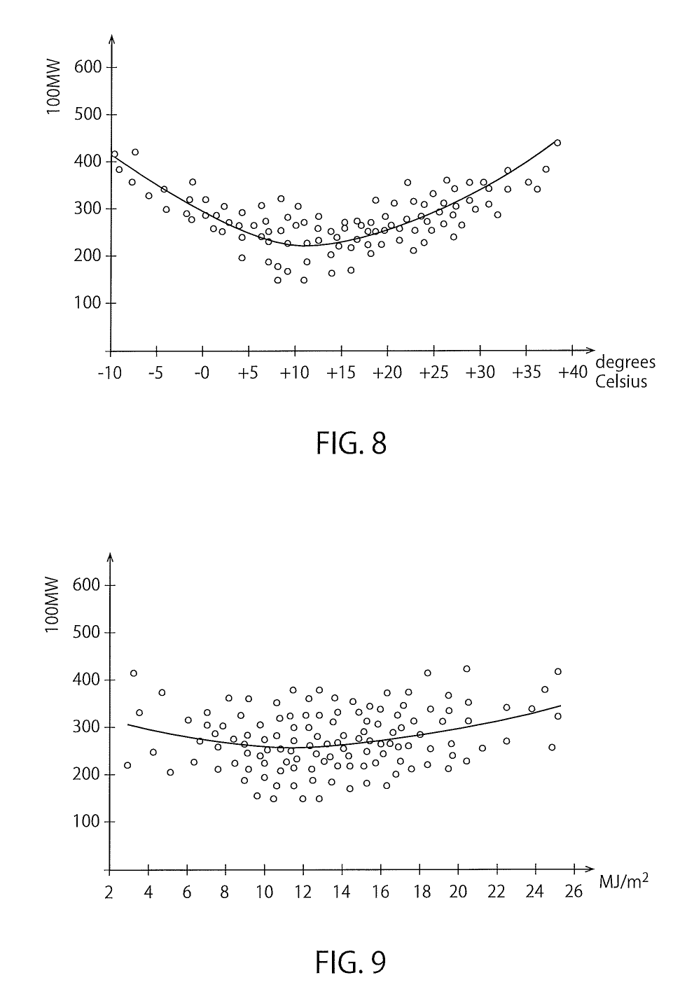

FIG. 8 is a diagram showing a response curve of the demand of electricity in respect to the temperature. FIG. 9 is a diagram showing the response curve of the demand of electricity in respect to the amount of solar irradiance. The vertical axes in FIG. 8 and FIG. 9 represent the consumption of electricity in the past in units of 100 MW. The horizontal axis in FIG. 8 is the temperature. The horizontal axis in FIG. 9 is the amount of solar irradiance in units of MJ/m². In both of the graphs, the horizontal axes represent the explanatory variables. The graphs in FIG. 8 and FIG. 9 are scattered plot diagrams. Each plotted sample corresponds to each sample in the demand data.

In each of the scattered plot diagrams, an approximated curve is shown. In the examples of FIG. 8 and FIG. 9, regression was done using a quadratic function. Therefore, approximated curves are drawn. However, if linear regression is used, a regression line could be drawn. Here, regression with the use of a quadratic function is only an example. It is possible to execute regression using polynomials with factors of different degrees, showing approximated curves with shapes that are different from FIG. 8 and FIG. 9. Also, an approximated curve or a regression line does not always have to be shown in the graphs. For example, it is possible to generate a scattered plot diagram without an approximated curve or a regression line.

Comparing between FIG. 8 and FIG. 9, the graph shown in the latter has greater variation of data samples compared to the approximated curve. If the result of regression is visualized, the graphs shown in FIG. 8 and FIG. 9 are displayed in the display 50.

Depending on the accuracy of the approximated curve (regression equation), the executed process branches (Step S104). If it is determined that the accuracy of the regression equation is sufficient, the process proceeds to step S108. If it is determined that the accuracy of regression equation is insufficient, the process returns to step S105.

In step S105, it is confirmed whether all the regression methods have been tested for the corresponding explanatory variable. Here, the regression methods are regression methods implemented in the location model generator 141. If there are regression methods that have not been tested yet, the regression method to be used is changed (Step S106). If all the regression methods have been tested for the corresponding explanatory variable, the regression equation for the corresponding explanatory variable is excluded from usage (Step S107).

Next, it is confirmed whether the regression equations for all the explanatory variables have been generated (Step S108). Here, the explanatory variables are all the measured values of weather or the predicted values of weather for a single location. If the regression equations for all the explanatory variables have been generated, the process proceeds to step S109. If there is an explanatory variable without a regression equation, the process returns to step S103. Then, regression is executed for a different explanatory variable.

If the regression equations for all the explanatory variables have been generated, the location model is generated by combining the regression equations (Step S109). For the location model, it is possible to use the Generalized Additive Model (GAM), for example. In the Generalized Additive Model, the predicted (forecasted) value for the demand of electricity can be obtained by including the sum of the regression equations. Thus, the contribution of each explanatory variable to the forecasted value of demand is clarified. If the response curve for each explanatory variable is visualized, it is possible to analyze the impact to the demand of electricity for factors including the temperature, the amount of solar irradiance and the humidity.

The following equation (1) is an example of the Generalized Additive Model f_{Rj}(t).

f_{Rj}(t)=d(t−t_{b})+Σfᵢⱼ+g(A) (1)

The Generalized Additive Model shown in equation (1) is the location model generated for each location. Here, t is the target time (date time) of demand forecast. j=1, 2, 3, . . . , jₘₐₓ corresponds to each location. Here, jₘₐₓ is the number of locations. d(t−t_{b}) represents the previous value of demand which serves as the reference value. t_{b} shows how many hours old the reference value is compared to the current time. fᵢⱼ represents each regression equation. fᵢⱼ can be the product of the regression equation (generated in step S103) and the normalization coefficient. Each regression equation fᵢⱼ has a different explanatory variable.

g(A) is the correction factor which provides effects, depending on the attributes. A is the attribute including weekdays, weekends, commuting time, events or like. Thus, g(A) gives different effects depending on the combination of attributes. For example, if attributes such as “new year holidays” which reduces the consumption of electricity in businesses, it is possible to set negative values to g(A). If a large-scale event such as the Olympic games are going to take place, it is possible to set positive values to g(A).

The following equation (2) is an example of a Generalized Additive Model using the observed values of weather and the predicted values of weather, included in the weather data.

f_{Rj}(t)=d(t−24)+f₁ⱼ(Tₜ)+f₂ⱼ(Iₜ)+f₃ⱼ(Sₜ)+g(A) (2)

Here, d(t−24) is the previous value of demand from 24 hours before the target date time of demand forecast. f₁ⱼ(Tₜ) is the regression equation for the temperature. Here, Tₜ is the observed value or predicted value of temperature at time t. f₂ⱼ(Iₜ) is the regression equation for the amount of solar irradiance. Here, Iₜ is the observed value or predicted value for amount of solar irradiance at time t. f₃ⱼ(Sₜ) is the regression equation for humidity. Here, Sₜ is the observed value or predicted value for the humidity at time t.

The aforementioned Generalized Additive Model is only an example. Thus, it is possible to use other methods to generate the location model. For example, it is possible to use multiple regression analysis for generating the location model. It is also possible to use machine learning methods such as neural networks or deep learning. The method of regression can be either linear or non-linear.

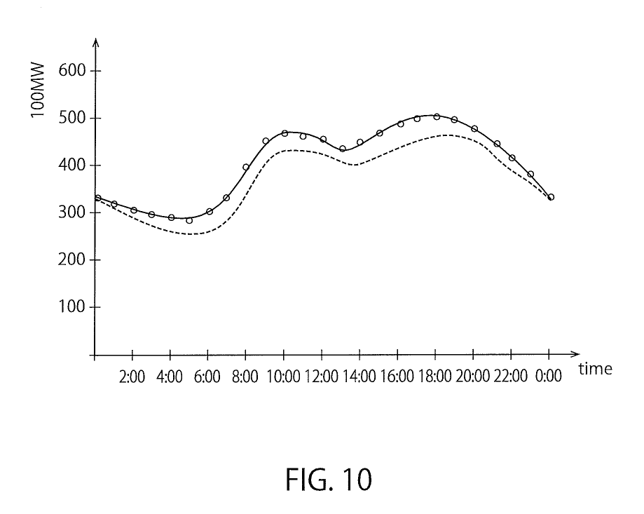

FIG. 10 is a diagram showing the result of demand forecast according to the location model. In the graph shown in FIG. 10, the vertical axis represents the demand of electricity in units of 100 MW. The horizontal axis represents the time. The forecasted value of demand by the location model is shown with a broken line. The actual demand of electricity is shown in a solid line. Referring to FIG. 10 it can be inferred that there is a gap between the forecasted values of demand provided by the location model and the actual demand of electricity. Thus, if only the weather data for a single location is used, it is not always possible to predict the demand of electricity for a certain geographical location with sufficient accuracy.

In the following, the explanation on the flowchart of FIG. 7 is continued.

If a location model for a single location is generated, it is confirmed whether the location models for all the locations belonging to the geographical region of demand forecast are generated (Step S110). If the location models for all the target locations are generated, the process of generating the location models is completed. If there are locations where the location models are not generated, the process returns to step S102 to generate a location model using the weather data of the location.

In the flowchart shown in FIG. 10, the generation of the regression equation and the location model is repeated. However, it is possible to repeat a plurality of regression equations and location models concurrently. Parallel execution of tasks is possible by using multicore CPUs or multiple computers, for example.

When the generation of the location model is completed, a plurality of location models is saved in the model database 154. If the area of geographical region for the demand forecast is large, there may be few hundred or few thousand location models. In order to reduce time and resources required for learning the demand forecasting model, the number of location models need to be reduced.

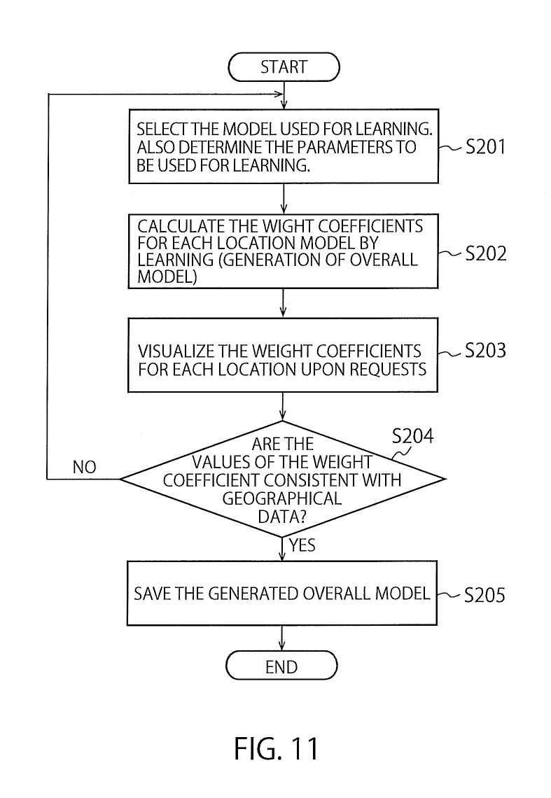

FIG. 11 is a diagram showing a generation process of the overall model. During the generation of the overall model, the location models that are incorporated into the overall model are selected, so that an overall model capable of providing accurate demand forecasts is generated. The weight coefficients for each location models are determined in the generation process of the overall model. The weight coefficients are determined based on the size of impact to the forecasted value of demand for the target geographical region. If the weather data for a location does not affect the forecasted value of demand for the target geographical region, the size of impact becomes zero. If the weather data for a location affects the forecasted value of demand for the target geographical region, the size of impact becomes greater. If the weather data for a location affects the forecasted value of demand for the target geographical region only slightly, the size of impact becomes small. In the following, the process of generating the overall model is explained in reference to the flowchart of FIG. 11.

First, the model and the parameters used for learning are determined (Step S201). It is possible to use various models of machine learning for generating the overall model. Below, a machine learning model is formalized.

The equation (3) below is an overall model Z_{θ} for parameters (θ₁, θ₂, θ₃, . . . , θ_{b}) presented in vector format.

$${Z}_{θ} ( \vec{x} ) = {\sum }_{j = 1}^{b} {θ}_{j} {f}_{Rj} ( {x}_{j} ) = {\vec{θ}}^{T} \vec{φ} ( \vec{x} ) \qquad ( 3 )$$

Here, a linear model is used for the overall model Z_{θ}. However, it is possible to use other models such as the kernel model. The overall model shown in equation (3) is only an example. For example, models including additional factors can be used.

In equation (3), the functions f_{Rj}(xⱼ) corresponding to each location models serves as the basis functions of a vector space. As shown in the equation (4) below, the dimension of the basis function vector are equal to the number of locations jₘₐₓ.

\vec{ϕ}(\vec{x})=(f_{R1}(x₁), f_{R2}(x₂), f_{R3}(x₃), . . . , f_{Rj}_{ₘₐₓ}(xⱼ_{ₘₐₓ})) (4)

During the learning of the overall model, a combination of the parameters (θ₁, θ₂, θ₃, . . . , θ_{b}) with the highest accuracy of demand forecast is obtained.

In the following, an example where sparse regularization is used for learning is described. In sparse regularization, a loss J (equation (5)) which includes the product of the regularization parameter λ and the norm is used for the sake of maintaining generalization performance.

J(\vec{θ})=J_{LS}(\vec{θ})+λ∥\vec{θ}∥₁ (5)

The value of the regularization parameter λ can be determined using sample data, for example.

If learning by sparse regularization is executed, the parameter θ which minimizes the loss J is found, as shown in the following equation (6).

Jₘᵢₙ(\vec{θ})=min J(\vec{θ}) (6)

The loss J is an amount which represents the gap between the training data xⱼ and the output of the model. It is possible to use the square error for the loss J, for example. It is possible to use other types of loss including the Huber loss, Tukey loss or the like.

In step S201, the model used for learning is determined. The candidate models include linear models, Gauss models or the like. Also, the type of loss used for learning is determined. Types of loss include the square error, Huber loss, Tukey loss or the like. The values of parameters in the model are determined too. Examples of parameters include the regularization parameter λ or the like. It is possible to use cross validation to determine the type of model, the type of loss and the value of the loss.

Next, the weight coefficients for each location model are calculated by learning, generating the overall model (Step S202). The weight coefficients can be calculated using learning by sparse regularization, for example.

In the following the process of learning by sparse regularization is described in more detail.

As shown in equation (7) below, an I₁ norm restriction is applied to the loss J in sparse regularization.

$${‖ θ ‖}_{1} = {\sum }_{j = 1}^{b} \vert {θ}_{j} \vert \qquad ( 8 )$$

The I₁ norm is the absolute value sum of the elements as shown in equation (8) below.

$${min}_{\vec{θ}} J ( \vec{θ} ) subject to {‖ θ ‖}_{1} \leq R \qquad ( 7 )$$

In the vector space spanned by the basis function vector of equation (4), the space where the condition of equation (8) is met has vertices in each axis. Here, each axis corresponds to either of the parameters. If the loss J is downward convex and the solution is on the vertex, the value of parameter becomes zero.

In sparse regularization, the solution (θ₁, θ₂, θ₃, . . . , θ_{b}) is calculated so that the values for some of the parameters θⱼ becomes zero. The solution can be calculated using various numeric calculation algorithms. The type of algorithm used is not limited.

If either of the parameters in the solution (θ₁, θ₂, θ₃, . . . , θ_{b}) become zero as a result of learning, it is possible to eliminate some factors of the basis function corresponding to the parameter, from the overall model Z_{θ}. The basis functions (location models) with corresponding parameters taking non-zero values are included in the overall model Z_{θ} with the parameter Z_{θ} as the weight coefficient. Thus, the overall model Z_{θ} includes a linear combination formed by multiplying the location model with the weight coefficient θⱼ. The location models included in the overall model Z_{θ} is a subset or a universal set of all the local models generated in the process generating the local models.

By reducing the number of location models included in the overall model Z_{θ}, it is possible to reduce the time required for generating the models and forecasting the demands. Also, compared to cases where weather data for all the locations are learned, it is possible to reduce the consumption of CPU time and storage space. If the weather data for only a limited number of locations can be obtained, the number of location models generated in the location model generator 141 is small, it is possible to generate an overall model Z_{θ} including all the location models, without reducing the number of location models in the overall model generator 142.

The selection of only some of the parameters in cases where many parameters exist in the learning data as described in the aforementioned example is called feature selection. In feature selection, parameters which are relevant to the result of the forecast (prediction) are selected while parameters with weaker relations are excluded from selection. Thereby, it is possible to prevent over-fitting (over-learning) and improve the generalization performance of the generated models.

If correlated parameters are included in the learning data, it is possible to narrow down the parameters to the representative parameters by feature selection. For example, if there is a plurality of location models for geographically adjacent locations, the location model for a representative location can be picked, considering the similarity in weather conditions within the geographically adjacent locations. Here, each location corresponds to the parameters in learning data.

As described in the aforementioned example, it is possible to avoid the multicollinearity in the learning data, if feature selection is applied. In the embodiment, feature selection corresponds to the process of extracting the locations (location models) from a set of multiple locations (locations).

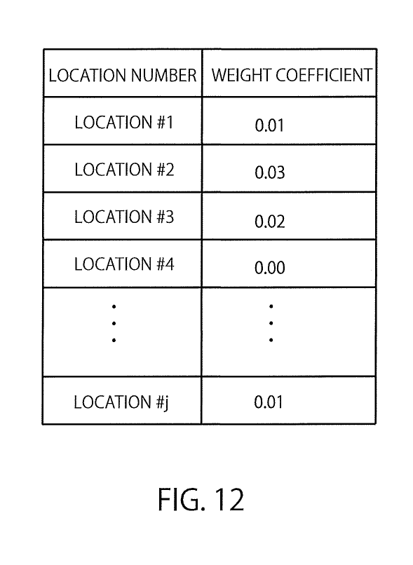

FIG. 12 is a diagram showing an example of a weight coefficient table for each location. In step S202, as a result of learning by the overall model generator 142, the weight coefficient table shown in FIG. 12 is generated. This table is saved in the model database 154. The weight coefficient table stores the weight coefficient for each location where the location model was generated.

In the example of FIG. 12, the weight coefficient for location #4 is 0.00. Thus, it can be inferred that the location model for location #4 is not included to the overall model Z_{θ}. Also, the weight coefficient for location #2 is 0.03 and the weight coefficient for location #3 is 0.02. Thus, compared to location #1 and location #j with weight coefficients of 0.01, the weight coefficients are configured to greater values.

In above, feature selection by sparse regularization was explained. However, it is possible to use other methods to reduce the number of locations. For example, it is possible to reduce the dimensions by using PCA (Principal Component Analysis) or SVD (Singular Value Decomposition) for reducing the number of locations included in the overall model.

It is possible to determine the weight coefficient by using methods other than sparse regularization. For example, it is possible to determine the weight coefficients based on statistical data. Using data such as the population, number of workers, number of households, the amount of shipments for products, the total area of facilities or the like for locations extracted by feature selection. For example, if an overall model which predicts the demand of electricity in daytime, locations with more workers has larger weight coefficients compared to locations where the daytime population is small. If the population of the locations is equal, locations with large values for the amount of shipments for products or the total area of facilities can have larger weight coefficients. The configuration of weight coefficients can be handled manually by users. Programs can be used to configure the weight coefficient automatically. If programs are used, it is possible to input the statistical data into functions. The output of the functions can be used as the weight coefficients for each location.

In the following, the explanation of the flowchart in FIG. 11 is continued.

After the overall model is generated, the weight coefficients for each location can be visualized upon requests (Step S203). The visualization of weight coefficients can be executed automatically by programs. Also, the visualization of weight coefficients can be executed when requests for users are received.

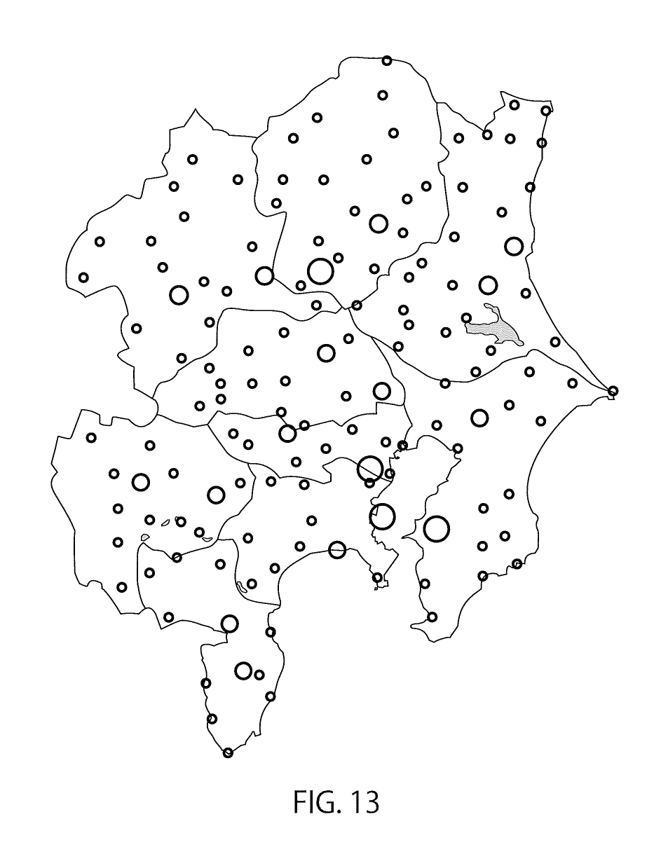

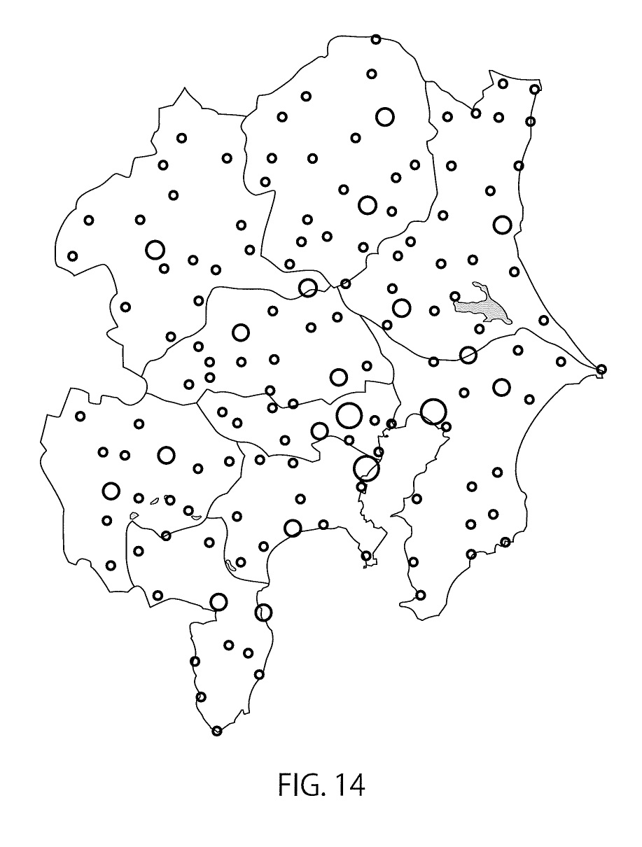

FIG. 13 is a diagram showing an example of weight coefficients for each location during daytime. FIG. 14 is a diagram showing an example of weight coefficients for each location during nighttime. FIG. 13 and FIG. 14 are maps including Tokyo metropolitan area, Kanagawa prefecture, Chiba prefecture, Saitama prefecture, Gunma prefecture, Tochigi prefecture, Yamanashi prefecture and an eastern part of Shizuoka prefecture. The circles drawn on the maps represent locations of AMeDAS meteorological stations. In each map, circles of different sizes are illustrated. The sizes of the circles are proportional to the value of the weight coefficients. For example, locations with the largest circles have weight coefficients of 0.03. Locations with the smallest circles have weight coefficients of 0.01. Locations with medium-sized circles have weight coefficients of 0.02.

In the examples shown in FIG. 13 and FIG. 14, the value of weight coefficients were represented with the sizes of the circles. However, other methods can be used to represent the weight coefficients. For example, it is possible to use colors and tones to represent the value of weight coefficients.

In step S203, the visualizing unit 16 can show the maps of FIG. 13 and FIG. 14 to the display 50.

Next, it is confirmed whether the values of the weight coefficient is consistent with the geographical data (Step S204). The consistency of the weight coefficients can be confirmed manually. If this is done, the users confirm the sizes of the weight coefficients displayed in the display 50. For example, if a large circle is shown on a location within a national park with very few people, it can be determined that the selection of locations or the configuration of weight coefficients should be reconsidered. If it is determined that there are issues in the configuration of weight coefficients, the users can regenerate the overall model (Step S201).

It is possible to implement a program which compares geographical data for each location with the weight coefficients in the model generator 14. The geographical data includes the population, the number of workers, the number of households, the amount of shipment for products, the total area of facilities or the like for each location. By using programs, it is possible to execute the consistency check automatically. The geographical data can be saved in the storage unit 15. It is possible to download the newest data from external systems including the demand information system 30 or the like. If the program determines that the weight coefficients are inconsistent with the geographical data, it is possible to regenerate the overall model (Step S201).

If it is determined that the values of the weight coefficient and the geographical data are consistent, the overall model generator 142 saves the overall model to the model database 154 (Step S205). If the consistency is verified, it is possible to provide forecasts of demand by using the overall model.

In above, the process for generating the overall model was explained. In the following, the process for forecasting demands with the generated overall model is described.

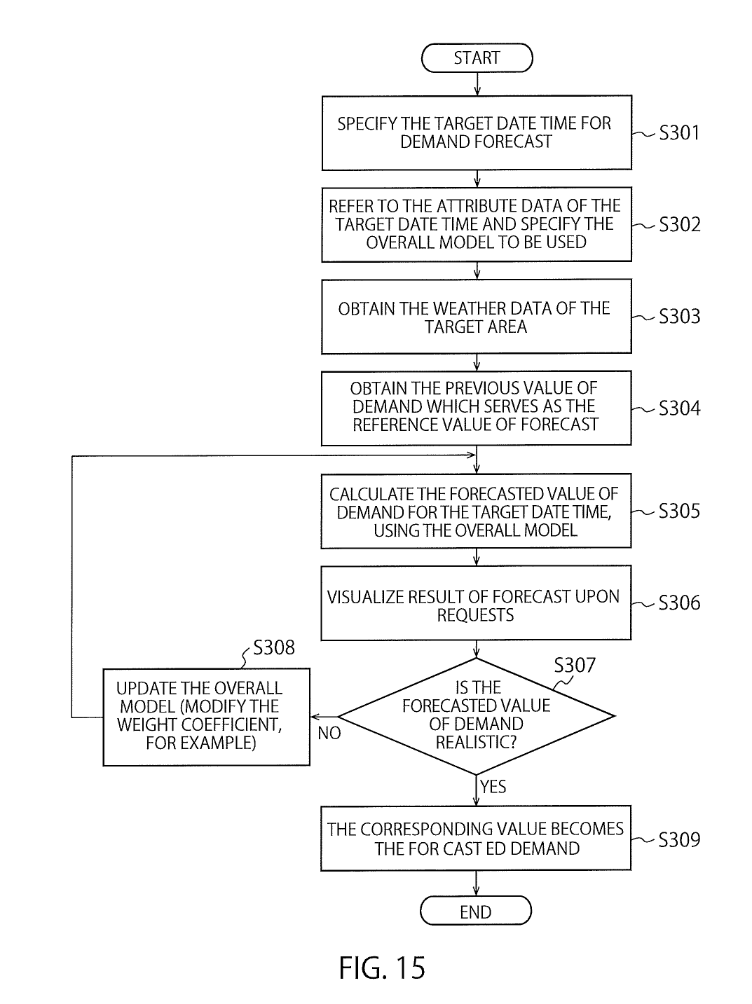

FIG. 15 is a flowchart showing a demand forecasting process by the overall model. In the following, the process for forecasting demands is explained in reference to the flowchart of FIG. 15.

First, the target date time for forecasting the demand is specified (Step S301). By manipulating the console 40, users can enter the target date time for forecasting the demand. The information on target date time is transferred to the forecasting unit 16 from the controller 17. The demand forecasting device 10 can be configured to provide forecasts of the demand periodically. The demand forecasting device 10 can be configured so that the demand forecast is executed when a specific condition is met.

The target date time of demand forecasting is not limited. For example, if the predicted values of whether for 12 hours later can be obtained as the weather data, it is possible to provide the demand forecasts for 12 hours after the current time. Also, it is possible to use the newest observed values of weather as the weather data to estimate the current demand. Also, it is possible to use observed values of weather from 2 months ago as the weather data to estimate the demand in 2 months ago. By comparing the estimated value of demand with the actual value of demand, it is possible to evaluate the accuracy of the overall model.

It is possible to provide forecasts of demand by specifying a specific time. Also, it is possible to specify multiple times within a certain period for providing forecasts of demands. For example, it is possible to provide a forecast of demand of 12 hours after the current time. It is also possible to provide forecasts of demand for each hour between 0:00 AM and 23:00 PM in the next day.

Next, by referring to the attribute information of the target date time of demand forecasting, the overall model which is going be used is determined (Step S302). The forecasting unit 16 refers to the attribute database 152 to read the attribute data for the target date time. If the attribute data for the specified target date time is not stored in the attribute database 152, the demand data updating unit 13 obtains the attribute data from the demand information system 30.

The forecasting unit 16 determines the overall model to be used for demand forecasting based on the attribute data. Here, a case when the attribute data shown in FIG. 6 is used is explained as an example. For example, assume that 11:00 AM in Jul. 27, 2020 is the target date time of demand forecasting. In FIG. 6, the attributes, “summer” and “large-scale events” are specified for 11:00 AM in Jul. 27, 2020. If an overall model specialized for large-scale events during summer is stored in the model database 154, the corresponding overall model is used. If there is an overall model for summer but not for large-scale events, the overall model for summer is selected. In this case, it is possible to reflect the increased consumption of electricity by adjusting the correction term.

If the overall model is specified, the weather data corresponding to the target area (geographical region) is obtained (Step S303). The weather data updating unit 12 obtains the required weather data from the weather information system 20. Here, the weather data updating unit 12 can obtain only the weather data for the locations included in the overall model selected in step S302, not the weather data for all the locations. For example, if the demand of electricity for 11:00 AM in Jul. 27, 2020 is being forecasted, it is possible to use the predicted value of weather for 11:00 AM in Jul. 27, 2020 as the weather data. If the weather data for 11:00 AM in Jul. 27, 2020 is already saved in the weather database 153, the data saved in the weather database 153 is used.

If the required weather data is obtained, the demand data which serves as the reference value for forecast is obtained (Step S304). In the embodiment, the previous value of demand (value of demand in the past) is used as the reference value for forecast. For example if the Generalized Additive Model of equation (2) is used, the actual value of demand for 11:00 AM in Jul. 26, 2020 which is 24 hours before the target date time is obtained in step S304. The demand data updating unit obtains the actual value of past demand from the demand information system 30. If the corresponding value of past demand is saved in the demand database 151, the value saved in the demand database 151 is used.

In the flowchart shown in FIG. 15, the processes are executed in the order of step S302, step S303 and step S304. However, the execution order of step S304 can be skipped with step S302 or step S303.

Next, the forecasted value of demand for the target date time is obtained by using the overall model (Step S305). The forecasting unit 16 enters the weather data and the demand data which serves as the reference value into the overall model as parameters. The output value of the overall model is used as the forecasted value of demand. The forecasted value of demand is saved to the forecast database 155 along with the target date time. It is possible to save the target geographical region, the identifier of the selected overall model and the timestamp of the data used for the forecast in the forecast database 155 as well.

After the forecasted value of demand is obtained, the forecasted result can be visualized upon requests (Step S306). The visualization of the forecasted result can be executed automatically by scripts or programs. Also, the visualization of the forecasted result can be executed when requests from users are received.

In step S306, the visualizing unit 18 can display the response curve (scattered plot diagram) to the display 50. For example, it is possible to plot the forecasted value of the demand to graphs shown in FIG. 8 and FIG. 9. The users can confirm the relationship between the points that have been plotted to the scattered plot diagram and the points corresponding to the values of demand in the past (approximated curve or regression line). If the newly plotted points are far from the other points or the approximated curve or regression line, it is possible to consider the replacement of the location model or the overall model.

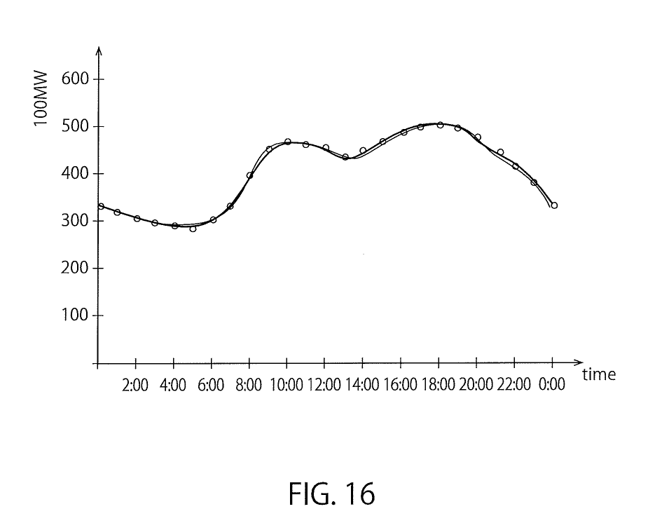

FIG. 16 is a diagram showing a result of demand forecast according to the overall model. In the graph if FIG. 16, the vertical axis represents the demand of electricity in units of 100 MW. The horizontal axis corresponds to the time. The demand forecast by the overall model is represented by a broken line. The actual demand of electricity is represented by a solid line. According to FIG. 16, the gap between the demand forecast and the actual demand of electricity is small. Thus, the accuracy of forecast is high. Comparing to the forecast provided by the location model which uses only the weather data for a single location (FIG. 10), it can be said that the accuracy of forecast improved dramatically in the overall model of FIG. 16.

In step S306, it is possible to show the graph shown in FIG. 16 in the display 50, visualizing the forecasted results. By using the graph of FIG. 16, it is possible to confirm the forecasted values of demand in chronological order. Data other than the actual value of demand could be shown on the graph. For example, it is possible to use the demand of electricity of a day with similar conditions for the sake of comparison. The previous day may have similar conditions as the target date. If the target date time is only a part of a day such as an hour or few hours, only the forecasted values of demand for the part of a day can be shown. Thus, as long as the forecasted values of demand can be verified, any form of presentation could be used for the graphs.

Next, it is confirmed whether the forecasted (anticipated) values of demand is realistic (S307). Any method can be used for confirming the forecasted values of demand. For example, if the forecasted result was visualized in step S306 according to the graph of FIG. 16, it is possible to verify the forecasted values by confirming the shapes of the graphs and the values of the peak. In the example shown in FIG. 16 it is determined that the forecasted values of demand provided by the overall model are realistic. Also, it is possible to generate response curves (scattered plot diagrams) for each factor including the temperature, the amount of solar irradiance and the humidity for verification of the result.

It is possible to verify the results automatically by using programs. For example, the forecasting unit 16 refers to the attribute database 152 to specify the previous date time with the same attributes as the target date time of demand forecasting. Then, the forecasting unit 16 reads the demand data for the corresponding date time from the demand database 151. The forecasting unit 16 compares the previous values of demand and the forecasted values of demand. It can be determined that if the difference between the value of the past demand and the forecasted value of demand is within a threshold value, the forecasted value of demand is realistic, for example. If the difference between the previous value of demand and the forecasted value of demand is greater than the threshold value, it is determined that the forecasted value of demand is not realistic.

Anomaly detection can be used for verifying the forecasted value of demand. Anomaly detection can be executed using machine learning models including the k-nearest neighbor algorithm, SVM (Support Vector Machines) or the like, for example.

If the previous value of demand with the same attribute as the target date time is not stored in the demand database 151, the demand data updating unit 13 obtains additional demand data from the demand information system 30. If the forecasting unit 16 cannot find a previous date time with the same attribute as the target date time in the attribute database 152, the demand data updating unit 13 accesses the demand information system 30 to update the demand data.

Depending on the result of verification, the process branches (Step S307). If it is determined that the forecasted value of demand is realistic, the corresponding value becomes the official forecasted value of demand (Step S309). If it is determined that the forecasted value of demand is not realistic, the overall model is modified to ensure that realistic values of demand can be forecasted (Step S308). The overall model can be updated automatically. The overall model can be updated when requests from the users are received.

The changes made to the overall model are not limited. For example, it is possible to adjust only the weight coefficients in the overall model. It is possible to execute the process of generating the overall model from step S201. Also, to improve the accuracy of the location models included in the overall model, the method used for generating the overall model can be changed. If the gap between the actual values of demand in the past and the forecasted value of demand is large in step S305, it is possible to expand the number of samples in the weather data and the demand data to make the amount of learning data sufficient.

By using the demand forecasting device according to the embodiment, it is possible to provide accurate forecasts of the demand based on the weather data. In order to avoid the difficulties of multicollinearity and over-fitting, the number of locations included in the overall model is limited. Thus, it is possible to reduce the time and computing resources necessary for generating models and providing forecasts. Also, the demand forecasting device according to the embodiment has features to visualize the characteristics of the models and the results of demand forecast. By using the visualization feature, it is possible to validate or modify the model visually, improving the accuracy of the forecast provided by the model.

There are many applications for the demand forecasting device according to the embodiment. For example, it is possible to use the demand forecasting device according to the embodiment in various fields including the supply plan of electricity, procurement of products, creating manufacturing plans for products, predicting the necessary resources in business, or the like.

### Second Embodiment

In the demand forecasting device according to the embodiment, weather data that can be obtained from the weather information system was used for generating models and providing demand forecasts. Therefore, the available content and the number of learning data depended on the observed values, predicted values, the timestamp and the locations within the weather data which could be obtained from the weather information system.

For example, if observed values in the past can be obtained from the weather information system but the values predicted in the future cannot be obtained, it becomes difficult to provide forecasts of the demand for 12 hours or 24 hours after the current time. The estimated demand in this case becomes the estimated value based on previous weather data, not the forecasted value of demand in the future. In this case, the demand forecasting device needs to predict the weather conditions in the future based on the latest weather data which can be obtained from the weather information system.

There are cases when the weather data that can be obtained from the weather information system is insufficient. For example, there are cases when the number of meteorological stations within the geographical region of demand forecast is small, cases when no weather forecasts for the locations belonging to the geographical region or cases when the granularity of weather forecasts are too coarse. The demand forecasting device needs to supplement the weather data by forecasting the weather for additional locations, using the numerical prediction model, before providing demand forecasts.

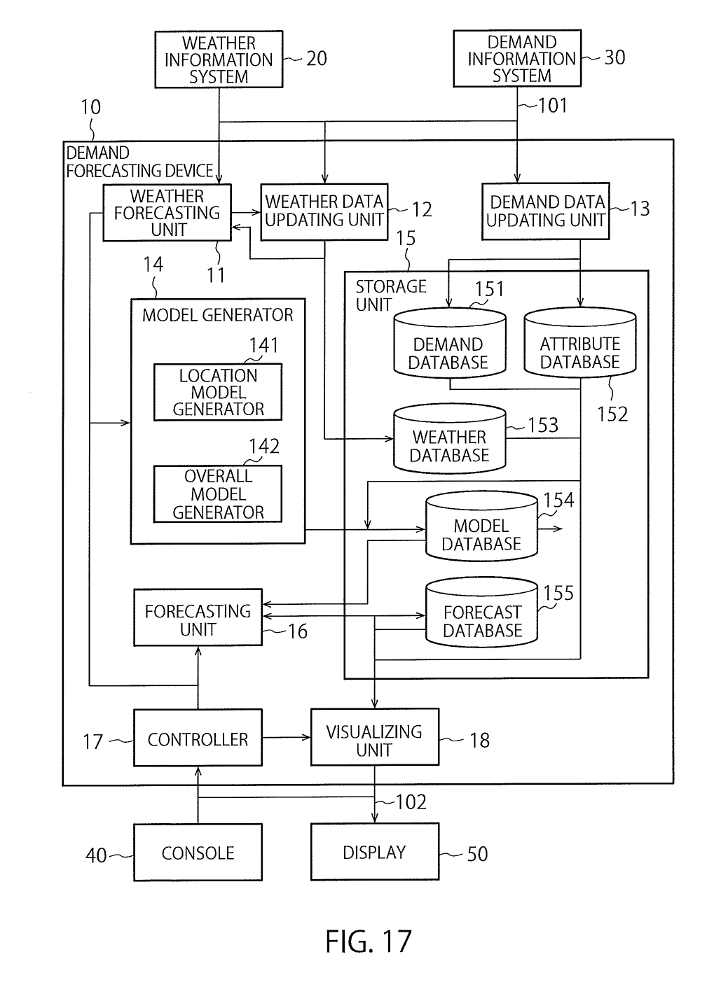

FIG. 17 is a diagram showing components of a demand forecasting system according to the second embodiment. In the following, the differences between the demand forecasting device according to the first embodiment and the demand forecasting device according to the second embodiment is explained in reference to FIG. 17.

To solve the aforementioned problems, the demand forecasting device according to the second embodiment has a weather forecasting unit 11, in addition to the components of the demand forecasting device according to the first embodiment. The other components within the demand forecasting system are similar to that of the demand forecasting system according to the first embodiment.

The weather forecasting unit 11 calculates the predicted values of weather for a specific date time in future using numerical weather prediction models. The weather forecasting unit 11 calculates the predicted value of weather for a location belonging to the geographical region based on the weather data. The type and the scale of the numerical weather prediction model which is used are not limited. The numerical prediction model can be a global ensemble forecasting system, a global numerical weather prediction model, a Meso-Scale model or a local forecast model. Also, Coupled Atmosphere-Ocean Global Climate models such as the seasonal ensemble forecasting system can be used. It is possible to switch the models depending on the specific conditions. It is possible to combine a plurality of models.

The weather forecasting unit 11 reads out the weather data including the numerical prediction model and the required initial values from the weather database 153 to forecast the weather. When the weather forecasting unit completes the weather forecast, the predicted values of weather are saved in the weather database 153. The predicted values of weather saved in the weather database 153 can be used for generating the local models and the overall models. The predicted values of weather can be also used for providing demand forecasts. The weather forecasting unit 11 supplements the weather data used by the demand forecasting device 10.

The weather data updating unit 12 can download the numerical prediction model from the weather information system 20. The downloaded numerical prediction model can be saved in the weather database 153. Thus, it is possible maintain the accuracy of the numerical prediction model.

In FIG. 17, the weather forecasting unit 11 is an internal component of the demand forecasting device 10. However, this is only an example. The weather forecasting unit 11 can be located in a different computer from the other components of the weather forecasting unit 11. For example, the weather forecasting unit 11 can be a scientific computer installed in a server room. The weather forecasting unit 11 can be a scientific computer of external organizations such as universities, research institutes, government agencies or the like. Thus, the configuration and location of the weather forecasting unit 11 is not limited.

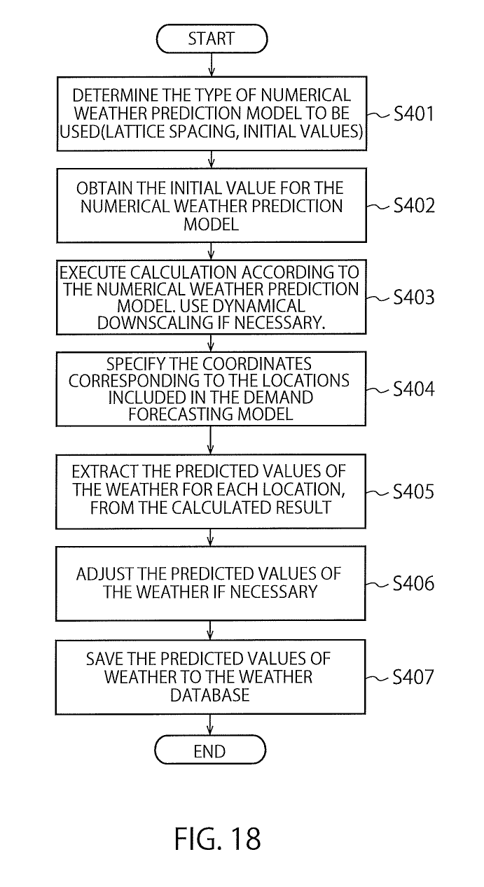

FIG. 18 is a flowchart showing calculation of weather data according to a numerical weather prediction model. In the following, the process of weather forecasting by the weather forecasting unit 11 is explained in reference to FIG. 18.

First, the type of numerical model to be used is determined (Step S401). The users can manipulate the console 40 to specify the locations where the weather data is needed and the target time for the weather forecast, based on the geographical region of the demand forecast and the target date time of the demand forecast. The controller 17 sends the locations where the weather data is needed and the target time for the weather forecast to the weather forecasting unit 11 when the request from the console 40 is received.

When the locations are specified, the weather forecasting unit 11 selects the numerical prediction model with the lattice spacing (resolution) suitable for calculating the predicted value of weather for the specified location. For example, when the demand forecast for an area of 10-90 square kilometers is going to be provided, local forecast models or Meso-Scale models with small lattice spacing (high resolutions) is selected. If the target time for the predicted values of weather is specified, the weather forecasting unit 11 can select the numerical prediction model based on the specified target time. For example, if the target time is 5 days later, models with long forecasted periods such as the global numerical weather prediction model can be selected.

In general, the initial value of the numerical prediction model should be based on the latest observed values of weather. Thus, the weather forecasting unit 11 uses the newest weather data as the initial value by default. In an ensemble forecast is going to be executed, the variation in the combination of initial values is determined. The types of numerical prediction models and the initial values can be determined automatically by scripts or programs. The users can specify the types of numerical prediction models and the initial values, manually.

If the type of numerical prediction model is determined, the initial value for the numerical prediction model is obtained (Step S402). The weather forecasting unit 11 notifies the required initial values to the weather data updating unit 12. If the newest weather data is saved in the weather database 153, the weather forecasting unit 11 forecasts the weather using the corresponding data as the initial value. If the weather data saved in the weather database 153 is not the newest data, the weather data updating unit 12 obtains the newest weather data from the weather information system 20. The newest weather data is saved in the weather database 153. In this case, the weather forecasting unit uses the weather data which is obtained as the initial value.

If the initial value is obtained, the calculation using the numerical prediction model is executed (Step S403). The calculated result is saved in the weather database 153. Based on necessities, dynamical downscaling can be used in step S403. If dynamical downscaling is used, it is possible to refine a specific region including the geographical region of demand forecast if models with large geographical scales such as the global numerical weather prediction model is used as the numerical prediction model.

For example, if a detailed weather forecast for an area of 10-90 square kilometers for a time which is over a week later, dynamical downscaling can be used. In dynamical downscaling, numerical prediction models with small granularities such as the Meso-Scale model and the local scale model can be used. It is also possible to use statistical downscaling such as regression. Numerical models and statistical downscaling can be combined in dynamical downscaling.

If the ensemble forecast is used, a plurality of initial values needs to be applied to the numerical prediction model, for calculating a plurality of predicted values of weather. For example, it is possible to use the average value if the plurality of predicted values as the final predicted value of weather.

Next, the coordinates corresponding to the locations included in the demand forecasting model within the numerical prediction model are specified (Step S404). For example, the latitude and the longitude for the location corresponding to the origin of the numerical prediction model is specified. Then, the latitude and the longitude for each location are converted to the coordinates in the numerical prediction model.

Then, from the calculated result, the predicted value of weather in the coordinates corresponding to each location is obtained (Step S405). Based on the coordinates calculated in step S404, physical information such as the temperature in each of the coordinates are extracted from the calculated results. Then, each location can be coupled with the predicted values of weather.

The predicted values of weather can be adjusted if necessary (Step S406). Depending on the numerical calculation models, the values of the calculated result may include some bias. Therefore, if different numerical prediction models are combined, it is possible to adjust the bias included in each numerical prediction model, improving the accuracy of the values.

Finally, the predicted values of weather for each location are saved in the weather database 153 as weather data (Step S407). Then, it is possible to generate the location models, generate the overall models, provide forecasts of the demand by using the predicted values of weather generated by the weather forecasting unit 11

Then, the process of forecasting the weather executed by the weather forecasting unit 11 is completed. The process of generating the location model, the process of generating the overall model and the process of providing the demand forecast are similar to that of the demand forecasting device according to the first embodiment.

Thus, by adding features for forecasting weather to the demand forecasting device, demand forecasts in smaller granularities becomes possible. Also, the demand forecast for few days later or few weeks later can be provided by using this feature.

### Third Embodiment

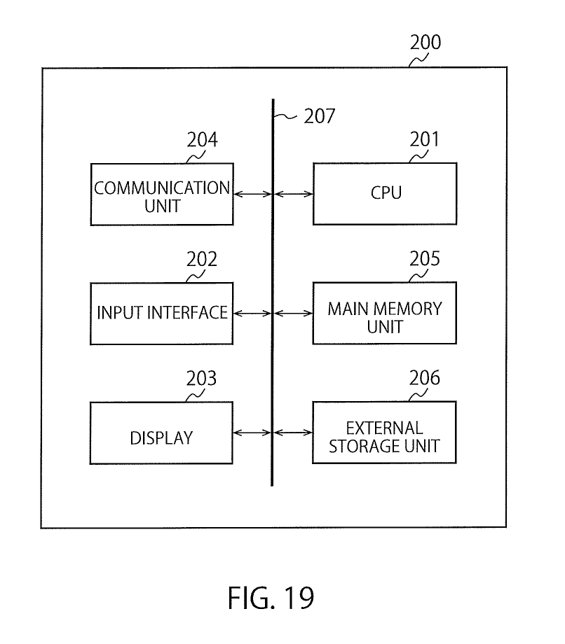

FIG. 19 is a diagram showing hardware configuration of the demand forecasting device. The demand forecasting device according to the embodiment is configured by using a computer 200. The computer 200 includes a CPU 201, an input interface 202, a display 203, a communication unit 204, a main memory unit 205, and an external storage unit 206. These components are connected with each other by a bus 207.

The CPU (Central Processing Unit) 201 executes the demand forecasting program which is a computer program on the main memory unit 205. The demand forecasting program is a program which provides the features of each component in the demand forecasting device. The demand forecasting program can be either a single program, a plurality of programs, scripts or a combination of these. The features of each component are enabled by having the CPU 201 execute the demand forecasting program.

The input interface 202 is a hardware circuitry which accepts the operation signals sent from input devices such as the keyboard, the mouse, the touch panel or the like.

The display 203 shows data provided from the demand forecasting device. The display 203 is a LCD (liquid crystal display), an electroluminescence display, a CRT (Cathode Ray Tube display) or a plasma display (PDP). However, other types of displaying devices can be used. Data provided from the computer 200 can be displayed in the display 203.

The communication unit 204 is a hardware circuitry which enables communication with external device by using wireless communication or wired communication. Data from external devices can be received via the communication unit 204. Data received from external devices can be stored in the main memory unit 205 and the external storage unit 206.

The main memory unit 205 stores data including the demand forecasting program, data required for executing the demand forecasting program, the data generated by the execution of the demand forecasting program or the like. The demand forecasting program is deployed on the main memory 205 for execution. The main memory 205 can be RAM, DRAM or SRAM but other devices can be used. The demand database 151, the attribute database 152, the weather database 152, the model database 154, the forecast database 155 can be stored in the main memory unit 205.

The external storage unit 206 saves data including the demand forecasting program, data required for executing the demand forecasting program, the data generated by the execution of the demand forecasting program or the like. When the demand forecasting program is executed, the aforementioned data are copied to the main memory unit 205. The external storage unit 206 is a hard disk, an optical disc, NAND flash memory or magnetic tapes, for example. However, other devices can be used. The demand database 151, the attribute database 152, the weather database 152, the model database 154, the forecast database 155 can be stored in the external storage unit 206.

The demand forecasting program can be installed in the computer 200. The demand forecasting program can be stored in storage media such as the CD-ROM. The demand forecasting program can be uploaded in the internet.

The terms used in the embodiments should be interpreted broadly. For example, the term “processor” may include a general-purpose processor, a central processor (CPU), a microprocessor, a digital signal processor (DSP), a controller, a micro-controller, and a state machine. Depending on situations, the “processor” may indicate an application specific integrated circuit, a field programmable gate array (FPGA), a programmable logic circuit (PLD), and the like. The “processor” may indicate a combination of processing devices such as a plurality of microprocessors, a combination of a DSP and a microprocessor, and one or more microprocessors cooperating with a DSP core.

As another example, the term “memory” may include any electronic component capable of storing electronic information. The “memory” can indicate a random access memory (RAM), a read only memory (ROM), a programmable read only memory (PROM), an erasable programmable read only memory (EPROM), an electrically erasable PROM (EEPROM), a nonvolatile random access memory (NVRAM), a flash memory, and a magnetic or optical data storage. The data saved in the devices mentioned above can be read by a processor. If the processor performs reads, writes or both reads and writes to the memory, the memory can be considered to be communicating electrically with the processor. The memory can be integrated with the processor. In such cases as well, the memory can be considered as communicating electrically with the processor.

The term “storage device” or “storage” may include any device that can store data using magnetic technology, optical technology, or nonvolatile memory. For example, the storage can be a HDD, an optical disk, a SSD, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A demand forecasting device comprising:
a location model generator generating location models each providing a forecasted value of demand for a geographical region including a plurality of locations, based on weather data for either of the plurality of locations and previous value of demand for the geographical region; and
an overall model generator generating an overall model based on the location models and coefficients that are determined based on size of impact to the forecasted value of demand, by the weather data of the locations.

2. The demand forecasting device according to claim 1, wherein
the weather data includes more than one item for observed values of weather or predicted values of weather.

3. The demand forecasting device according to claim 2, wherein
the overall model generated by the overall model generator includes a plurality of location models generated by the local model generator.

4. The demand forecasting device according to claim 2, wherein
the overall model generated by the overall model generator includes a linear combination formed by multiplying the location model with the coefficient.

5. The demand forecasting device according to claim 2, wherein
the overall model generator uses sparse regularization to calculate the coefficients and to select the location models that are included in the overall model, based on the values of the coefficients.

6. The demand forecasting device according to claim 2, further comprising
a forecasting unit which calculates the forecasted value of demand in the geographical region by entering the predicted value of weather and the previous value of demand into the overall model.

7. The demand forecasting device according to claim 6, wherein
the predicted value of weather entered into the overall model by the forecasting unit is the predicted value of weather for a target date time of demand forecast.

8. The demand forecasting device according to claim 7, wherein
the weather data and the previous value of demand used for generation of the location model is the weather data and the previous value of demand for a plurality of previous date times which satisfy specific conditions.

9. The demand forecasting device according to claim 8, wherein
the overall model generator generates the overall model which can provide the forecasted value of demand for the specific conditions.

10. The demand forecasting device according to claim 9, wherein
the forecasting unit selects the overall model to be used based on the specific conditions of the target date time of demand forecast.

11. The demand forecasting device according to claim 2, further comprising
a visualizing unit which displays a first graph which is a scattered plot diagram showing a relation between the previous value of demand and the weather data.

12. The demand forecasting device according to claim 11, wherein
the visualizing unit displays a regression line or a approximated curve overlapping the scattered plot diagram.

13. The demand forecasting device according to claim 11, wherein
the visualizing unit displays a map which shows size of the coefficients for each location corresponding to the predicted value of weather or the observed value of weather used in generation of the location model.

14. The demand forecasting device according to claim 11, wherein
the visualizing unit displays a second graph which shows the forecasted value of demand and the previous value of demand for a plurality of date times.

15. The demand forecasting device according to claim 2, further comprising
a weather forecasting unit which calculates the predicted value of weather for the location belonging to the geographical region based on the weather data.

16. The demand forecasting device according to claim 15, wherein
the weather forecasting unit calculates the predicted value of weather for a specific date time in future.

17. The demand forecasting device according to claim 1, wherein
the location model generator generates the location model using a Generalized Additive Model.

18. The demand forecasting device according to claim 1, wherein
the previous value of demand is a previous value of demand for electricity and the forecasted value of demand is demand of electricity.

19. A demand forecasting method comprising the steps of:
generating location models each providing a forecasted value of demand for a geographical region including a plurality of locations, based on predicted values of weather or observed values of weather for either of the plurality of locations and previous values of demand for the geographical region;
generating an overall model based on the location models and coefficients that are determined based on size of impact to the forecasted value of demand, by the predicted value of weather or the observed value of weather in the location;
calculating the forecasted value of demand in the geographical region by entering the predicted value of weather and the previous value of demand into the overall model.

20. A non-transitory computer readable medium having a computer program stored therein which causes a computer to execute processes comprising:
generating location models each providing a forecasted value of demand for a geographical region including a plurality of locations, based on a predicted value of weather or a observed value of weather for either of the plurality of locations and previous value of demand for the geographical region;
generating an overall model based on the location models and coefficients that are determined based on size of impact to the forecasted value of demand, by the predicted value of weather or the observed value of weather in the location;
calculating the forecasted value of demand in the geographical region by entering the predicted value of weather and the previous value of demand into the overall model.
